(19) United States
(12) Patent Application Publication
(10) Pub. No.: US 2007/0290139 A1
(43) Pub. Date: Dec. 20, 2007

(54) Subject proximity detector for a nuclear imaging device and method of detector positioning using same

(76) Inventor: Eric G. Hawman, Schaumburg, IL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/453,574

(22) Filed: Jun. 15, 2006

(51) Int. Cl. G01T 1/166

(52) U.S. Cl. 250/363.04

(57) ABSTRACT

A nuclear imaging device for positioning detectors in proximity to a subject generally includes one or more detectors disposed with respect to one another at an angle and at a distance from the subject. Each of the detectors has a field of view having a spatial window for receiving radiation. A positioning assembly is included for radially disposing the detectors away from the subject when one of the spatial windows receives attenuated radiation and toward the subject when non-attenuated radiation is received. A method according to the invention includes disposing a subject between a source of radiation and a field of view of the detectors, receiving radiation emanating from the source within the spatial window, determining the spatial location of the subject based on the radiation received, and positioning the detectors or the subject relative to the other based on the spatial location of the subject.

### FIELD OF THE INVENTION

The present invention relates generally to nuclear imaging devices, and more particularly, to an apparatus and method for determining the proximity of a subject to a detector assembly of a nuclear imaging device.

### BACKGROUND OF THE INVENTION

Nuclear medicine is a unique medical specialty wherein radiation is used to acquire images which show the function and anatomy of organs, bones or tissues of the body. Generally, radiopharmaceuticals are introduced into the body, either by injection or ingestion, and are attracted to specific organs, bones or tissues of interest. Such radiopharmaceuticals produce gamma photon emissions which emanate from the body and are captured by Anger-type gamma cameras. Anger-type gamma cameras typically comprise collimators, scintillating crystals and photodetectors. Generally, collimators allow only certain gamma photons traveling along specific paths to interact with the scintillation crystals; the interaction of the gamma photons with the scintillating crystals produces flashes of light or “events,” which are ultimately detected by photodetectors, which typically comprise photomultiplier tubes. The spatial location or position of the light events are then calculated and stored. In this way, an image of the organ or tissue under study can be created from the detection of the distribution of the radioisotopes in the body.

In some existing systems, for example, in single photon emission computed tomography (SPECT) systems of the transaxial rotational camera type, an Anger-type gamma camera is rotated about a region of a subject to be scanned. Typically, rotation is in a plane generally orthogonal to the cranial-caudal axis of the subject and produces an image of a cross-sectional slice of the subject, e.g., a portion of the human body.

In general, for certain Anger-type gamma cameras, also referred to as detectors, e.g., parallel hole collimated detectors, because resolution decreases with distance, it is important to keep the detector as close to the subject as possible, without contacting the subject, in order to improve resolution and image quality. Accordingly, during rotation of the detector about a subject, e.g., a human subject, the path of the detector about the subject comprises a non-circular orbit, e.g., an elliptical orbit, so as to minimize the average distance between the detector and the patient. Various nuclear imaging systems capable of non-circular orbits are known, as are methods for determining/programming an orbit about a subject. Examples of such systems are disclosed in U.S. Pat. No. 4,503,331 (the '331 patent) and U.S. Pat. No. 4,593,189 (the '189 patent), as well as U.S. Pat. Pub. No. 2004/0263865 (the '865 application), which are further described herebelow.

In the system described by the '331 patent, a nuclear medicine technologist pre-programs a detector path by first manually moving it to a standard position, e.g., at 9:00 o'clock and 12:00 o'clock positions, adjacent the patient. The path is then calculated based on the manually positioned detector and the detector then follows the calculated orbit during subsequent image acquisition. While this type of system is generally sufficient for producing a nuclear image, manual positioning takes some time, is subject to human error, and allows only standard paths to be input/followed.

The '189 patent and '865 application each disclose nuclear imaging systems and methods wherein light beams and light sensors are used for determining and maintaining the position of a detector in close proximity to a subject being imaged. Generally, in these type of systems, one or more light or laser beams are parallelly disposed at a distance from the surface of the detector. Consequently, breaking of the light beams by the subject allows the imaging device to determine the position of the subject and move the detector accordingly. The primary difference between these two systems is that in the system described in the '189 patent, the subject is pre-scanned to determine a path about the subject and then imaged, whereas in the system described by the '865 application, the path is determined during the actual imaging procedure by using a feedback loop. A problem with each of these systems, however, is that they each use light beams and/or laser beams, which are not otherwise needed and which increase the cost of the imaging system.

What is needed then is a system and method that addresses the above-identified deficiencies.

### SUMMARY OF THE INVENTION

According to one aspect, a nuclear imaging device comprises first and second detectors and a positioning assembly is configured to dispose the first detector away from the subject when the spatial window of the second detector receives substantially attenuated radiation and toward the subject when the spatial window of the second detector receives substantially non-attenuated radiation. In such aspect, the positioning assembly is also configured to dispose the second detector away from the subject when the spatial window of the first detector receives substantially attenuated radiation and toward the subject when the spatial window of the first detector receives substantially non-attenuated radiation.

In some aspects, the angle is adjustable. In some aspects the angle is 90°. In some aspects, the spatial window is adjacent an inward edge of the field of view of the one or more detectors. In some aspects, the detectors are configured to be transaxially disposed about an axis of the subject and/or along an axis of the subject.

In some aspects according to the invention, a nuclear imaging device comprises a control unit for determining the spatial location of the subject based on the attenuated and non-attenuated radiation received by the spatial window of the one or more detectors. In some aspects, the control unit determines an orbital path of the one or more detectors about and along the subject based on the spatial location of the subject. In some aspects the control unit controls movement of the one or more detectors based on the spatial location.

A method for spatially positioning one or more detectors of a nuclear imaging device in proximity to a subject according to the invention comprises disposing a subject between a source of radiation and a field of view of the one or more detectors, receiving attenuated and non-attenuated radiation emanating from the source within a spatial window of the field of view, wherein the attenuated radiation substantially corresponds to the subject, determining a spatial location of the subject with respect to the one or more detectors based on the attenuated and non-attenuated radiation received within the spatial window, and positioning the one or more detectors or the subject relative to the other based on said spatial location.

In some aspects, determining the spatial location of the subject comprises radially disposing the one or more detectors with respect to an axis of said subject. In some aspects determining the spatial location of the subject comprises transaxially rotating the one or more detectors about an axis of the subject. In some aspects, determining the spatial location of the subject comprises disposing the one or more detectors along an axis of the subject. In some aspects of the method, the one or more detectors are radially disposed away from an axis of the subject when the spatial window receives attenuated radiation. In some aspects, one or more detectors are radially disposed toward an axis of the subject when the spatial window receives non-attenuated radiation. In some aspects, the spatial window is adjacent an edge of the field of view of the one or more detectors.

In other aspects of the invention, a nuclear imaging device comprises first and second detectors disposed with respect to one another at an angle. In such aspect, each of the first and second detectors is configured for receiving attenuated and non-attenuated radiation emanating from the source within a spatial window thereof. The first detector is disposed away from the subject when the spatial window of the second detector receives substantially attenuated radiation and toward the subject when the spatial window of the second detector receives substantially non-attenuated radiation. The second detector is disposed away from the subject when the spatial window of the first detector receives substantially attenuated radiation and toward the subject when the spatial window of the first detector receives substantially non-attenuated radiation. In some aspects, the angle is adjustable. In some aspects the angle is 90°.

In some aspects, the method includes calculating an orbital path of the one or more detectors about and along the subject based on the spatial location of the subject.

In some aspects, a method for spatially positioning one or more detectors of a nuclear imaging device in proximity to a subject and obtaining a nuclear image of the subject comprises disposing a subject between a source of radiation and a field of view of the one or more detectors, receiving attenuated and non-attenuated radiation emanating from the source within a spatial window of the field of view, the attenuated radiation substantially corresponding to the subject, determining a spatial location of the subject with respect to the one or more detectors based on the attenuated and non-attenuated radiation received within the spatial window, positioning the one or more detectors or the subject relative to the other, and scanning the subject to obtain a nuclear image thereof.

### BRIEF DESCRIPTION OF THE DRAWINGS

The invention will now be more fully described by way of example with reference to the accompanying drawings in which:

FIG. 1 is a perspective view of a nuclear imaging device according to one embodiment of the invention;

FIG. 2 is a schematic illustration of a pair of detectors of a nuclear imaging device according to one embodiment of the invention;

FIG. 3 is a schematic illustration of a nuclear imaging device further illustrating detector components;

FIGS. 4-8 are schematic illustrations showing adjustment of a detector according to one embodiment of the invention based upon the reception of attenuated and non-attenuated radiation;

FIGS. 9-10 are schematic illustrations showing a pre-scan according to one embodiment of the invention for obtaining information regarding the position of a subject relative to a detector;

FIGS. 11 and 12 are schematic illustrations of an imaging device according to one embodiment of the invention illustrating independent movement of one or more detectors along the longitudinal axis of a subject and movement of the subject relative to the detectors; and,

FIG. 13 is an illustration of a subject proximity detector according to one embodiment of the invention as applicable to a cardiac-type SPECT imaging device.

### DETAILED DESCRIPTION OF EXEMPLARY EMBODIMENTS

The present invention will now be described and disclosed in further detail. It is to be understood, however, that the disclosed embodiments are merely exemplary of the invention and that the invention may be embodied in various and alternative forms. Therefore, specific structural and functional details disclosed herein are not to be interpreted as limiting the scope of the claims, but are merely provided as an example to teach one having ordinary skill in the art to make and use the invention.

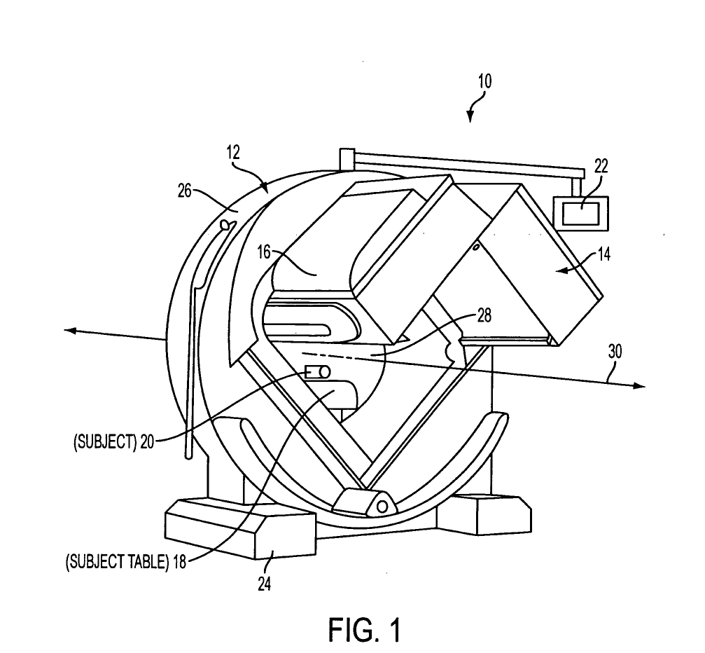

Referring now to FIG. 1, which is a perspective view of a nuclear imaging device according to the invention, a SPECT nuclear imaging device 10 is shown as generally comprising a gantry assembly 12, a pair of detectors 14 and 16, a subject table 18 for supporting subject 20, which can be a human or phantom, and a control unit 22. It should be appreciated by those having skill in the art that while the instant disclosure describes the invention relative to a SPECT nuclear imaging device, e.g., of a type disclosed in U.S. patent application Ser. No. 10/608,704, filed Jun. 29, 2003, which application is incorporated herein by reference in its entirety, the instant invention can be used in combination with other types of nuclear imaging device that comprise Anger-type gamma cameras, e.g., PET nuclear imaging devices.

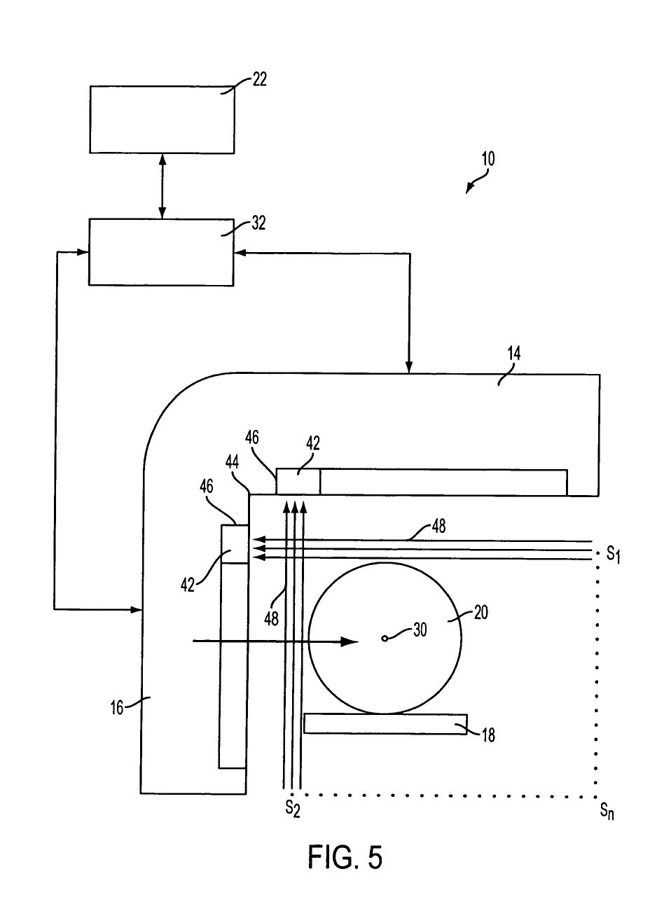

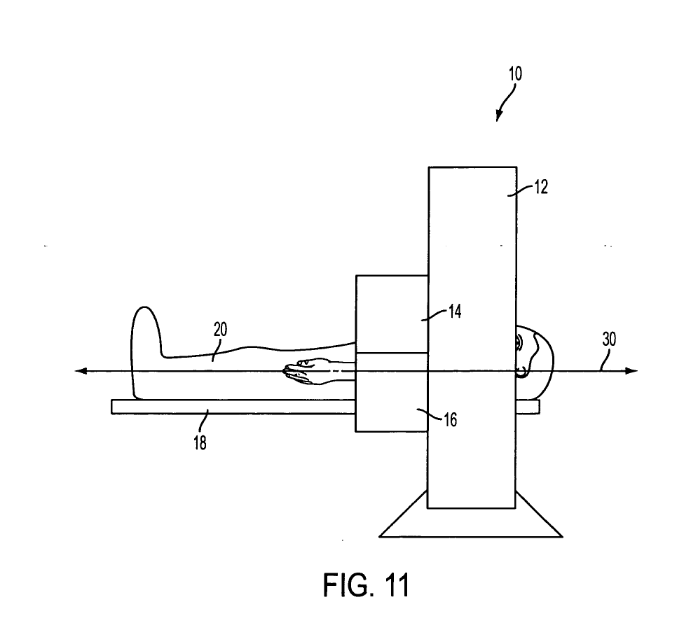

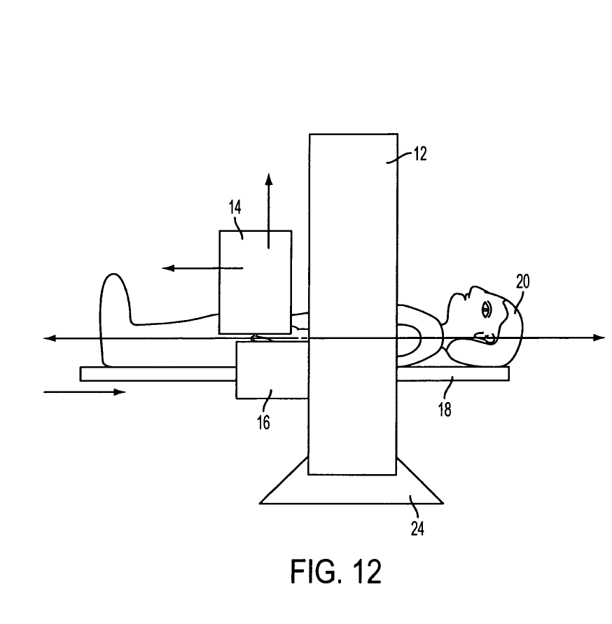

As can be seen in FIG. 1, gantry assembly 12 is illustrated as generally comprising a base 24 and annular portion 26, which forms aperture 28. Base 24 is generally provided for supporting annular portion 26, which is shown as comprising a generally O-shaped structure. Aperture 28 is configured for receiving subject table 18, and subject 20, therein. Annular portion 26 supports the pair of detectors 14 and 16 and can include tracks, channels or guides for positioning the detectors thereabout, e.g., around the annular portion and about longitudinal axis 30, subject table 18 or subject 20. It should be appreciated by those having skill in the art, however, that while the detectors are generally configured for arcuate movement about annular portion 26, the movement of the detectors about the annular portion is dependent upon the specific configuration of the tracks, channels or guides, and can be linear, or otherwise. Also, while movement of detectors 14 and 16 is disclosed as generally occurring about longitudinal axis 30 (and subject table 18 and/or subject 20) (transaxially), as illustrated in FIGS. 5-8 and 11 and 12, the detectors 14 and 16 also can be moved radially or longitudinally independent of one another and relative to longitudinal axis 30, subject table 18 or subject 20. Accordingly the movement of the detectors relative to a subject can occur, for example, in a helical manner. Additionally, while detectors 14 and 16 are generally described herein as moving with respect to a stationary subject or subject table, the device can be configured such that subject table 18 moves relative to the detectors (See FIGS. 11 and 12).

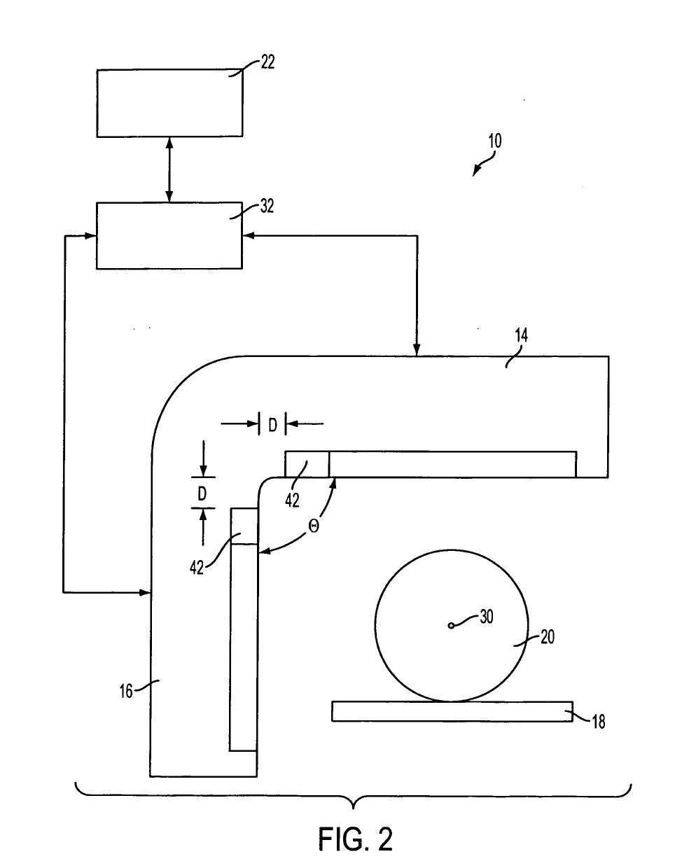

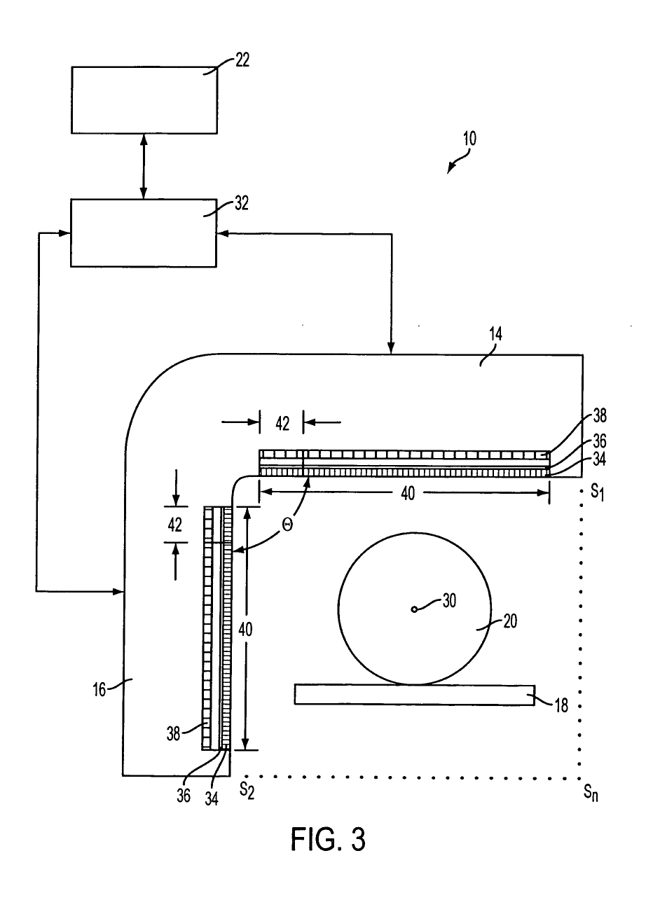

As illustrated in FIGS. 2 and 3, detectors 14 and 16 can comprise Anger-type gamma camera detectors, which generally comprise collimators, scintillating elements and one or more photodetectors. Detectors 14 and 16 are generally configured for being positioned relative to subject 20 along a path or orbit about the subject during scanning and for receiving radiation emanating from a source of radiation inside the subject. Detectors 14 and 16 can also be positioned relative to subject 20 for purposes of obtaining data regarding sources of radiation including, sources internal to the subject and sources external to the subject, e.g., for obtaining attenuation data pertaining to the subject, e.g., an attenuation or μ-map, or zeroing the imaging device or obtaining information regarding background radiation levels. Also, while detectors 14 and 16 are illustrated as being fixed to one another at an angle θ, which in the illustrated embodiment is 90°, as shown in FIGS. 11 and 12, detectors 14 and 16 can be disposed angles other than 90° and configured for movement independent of and relative to one another, e.g., along annular portion 26 or along one or more detector axes such that each detector can be moved upward or downward, inward or outward, leftward or rightward, or rotated. Detector movement can be provided by one or more motors or actuators 32, which can be controlled by control unit 22.

Control unit 22 is provided for controlling the nuclear imaging device 10, and more particularly, for automating imaging and scanning processes, e.g., sending and receiving data, calculating paths or orbits relative to the subject, moving the detectors relative to the subject, etc. Control unit 22 can comprise a computer including a microprocessor, which can be programmable, a memory, a monitor, and data input device, such as a touchscreen-type monitor, keyboard, mouse or joystick, etc. Control unit 22 is configured for sending and receiving signals to/from the gantry assembly 12 and the detectors 14, 16 for controlling movement thereof, as well as for receiving and processing data, e.g., radiation from the subject, attenuation radiation data, or data regarding the spatial location of the detectors relative to the subject. The computer can also be configured for processing the data received from the detectors such that movement of the gantry assembly, the one or more detectors, or the subject table, if configured for movement, can be controlled. Computer control of the gantry assembly, detectors and/or subject table can be pre-programmed according to standard criteria, manually controlled via a data input device, or controlled according to data received by the detectors, e.g., radiation data; movement can also occur in real time by means of a feedback loop.

A detector 14, 16 according to the claimed invention is generally configured for receiving radiative particles emanating from a source of radiation for purposes of preparing an image of the subject. In the case of a human subject, a source of radiation is ingested by or injected into a person such that the radiative particles can be transported through the body and emitted from targeted organs or tissues. Prior to obtaining an image of such distribution, and prior to the subject being injected with or ingesting the source of radiation, the imaging device is typically tested or calibrated to ensure that it is in proper working order and to account for any background radiation. Also, attenuation maps, or μ-maps, pertaining to the subject to be imaged are typically prepared by exposing the subject to an external source of radiation. According to the instant invention, it is possible to obtain information regarding the spatial position of the subject relative to the detectors during such exposure.

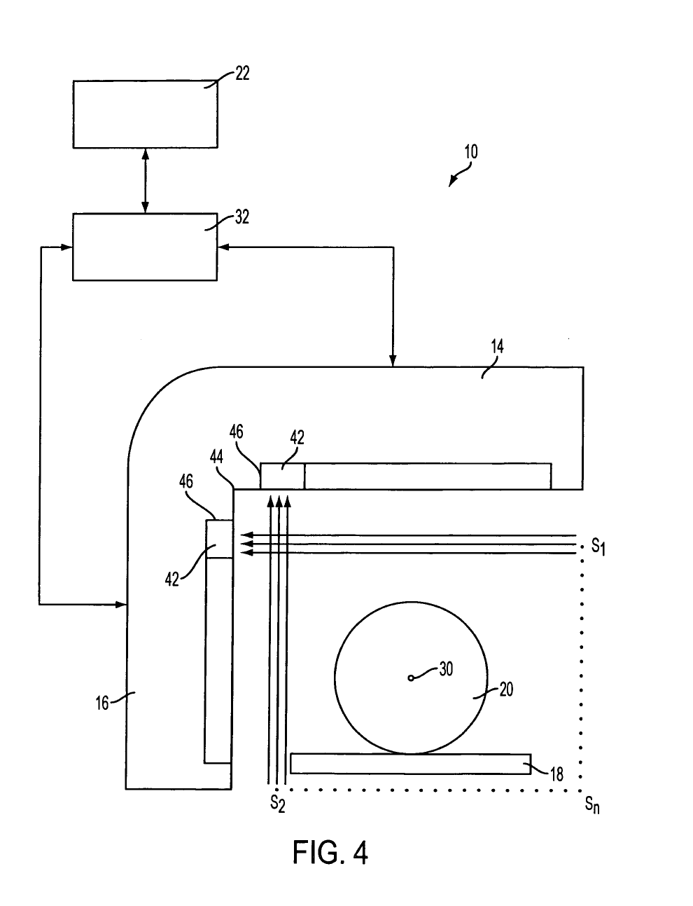

More specifically, as shown more clearly in FIG. 3 each of detectors 14 and 16 includes a collimator 34, a scintillator 36 and a plurality of photodetectors 38, which define a Field of View (FOV) 40. Typically, FOV 40 is defined by the area of a portion of the face of the detectors, but factors that affecting the FOV can include the size/type of collimator 34, the size/type of scintillator 36, the number/size/type/operational state of photodetectors 38, etc. As seen in FIGS. 2-10, a portion of each FOV 40 is shown as further comprising a spatial window 42. Spatial windows 42 are provided for receiving radiation from one or more external radiation sources S₁, S₂ . . . Sₙ such that the positional location of the detectors relative to the subject can be determined. Using this information, the position of the detectors or the subject table can be controlled or modified. In the embodiment illustrated, spatial windows 42 are illustrated as being located proximate and adjacent to interface 44 between each of detectors 14 and 16. More specifically, spatial windows 42 are disposed proximate, and adjacent to, sides 46 of each FOV 40.

As shown more clearly in FIGS. 5-8, depending upon the position of the detectors relative to the subject, e.g., during pre-scan procedures to “zero” the nuclear imaging device, to obtain background radiation information, or attenuation data regarding a subject, spatial windows 42 can receive both attenuated and non-attenuated radiation from one or more of external radiation sources S₁, S₂. That is, where one or more external radiation sources S₁, S₂ are disposed opposite detectors 14 and 16, preferably substantially opposite the spatial windows 42, and a subject disposed between the detectors and the external radiation sources, depending upon the position of the detectors 14 and 16 relative to the subject, the spatial windows 42 will receive attenuated or non-attenuated radiation.

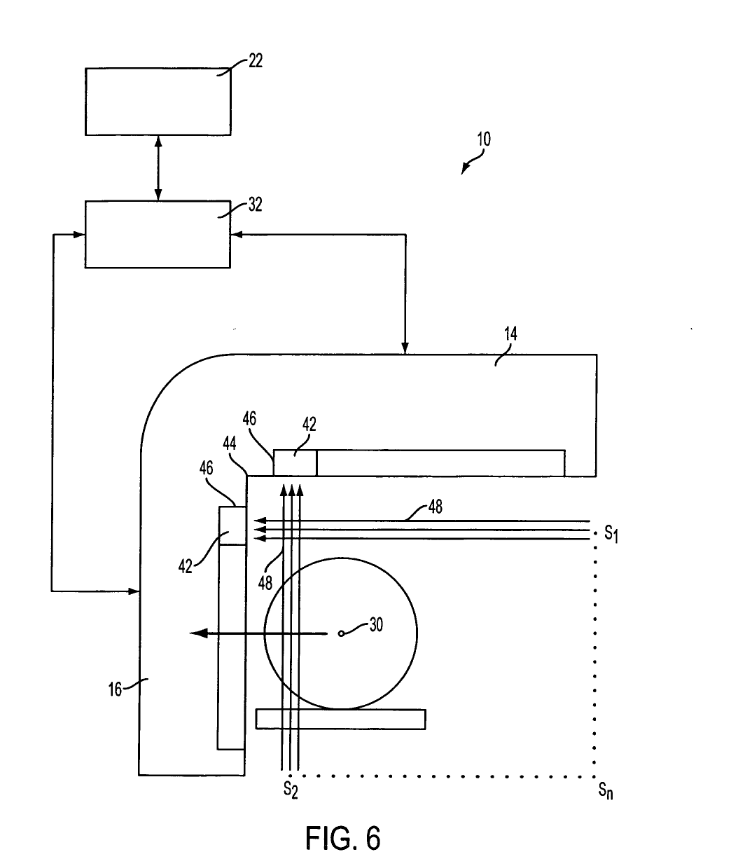

Referring specifically now to FIGS. 5 and 6, which illustrate conditions wherein the spatial window 42 of detector 14 receives radiation 48 from known source of radiation S₂, which has not been attenuated by the subject 20 (FIG. 5) and radiation 48 that has been attenuated by the subject 20 (FIG. 6). As shown in FIG. 5, when the spatial window of detector 14 receives non-attenuated radiation from known radiation source S₂, and/or the number of counts (C) of radiation, or energy levels of radiation received within the spatial window are above certain criteria, the control unit 22 directs detector 16 toward the subject 20, in the direction of the rightwardly directed arrow, until radiation received within spatial window 42 falls within a predetermined attenuation range, count range or energy level range. In contrast, as shown in FIG. 6, if the spatial window 42 receives attenuated radiation, e.g., as being attenuated by the subject 20, and the count range or energy level range is below a certain predetermined threshold, the control unit directs detector 16 away from the subject, in the direction of the leftwardly directed arrow until radiation received within the spatial window 42 falls within a predetermined attenuation, count, or energy level range.

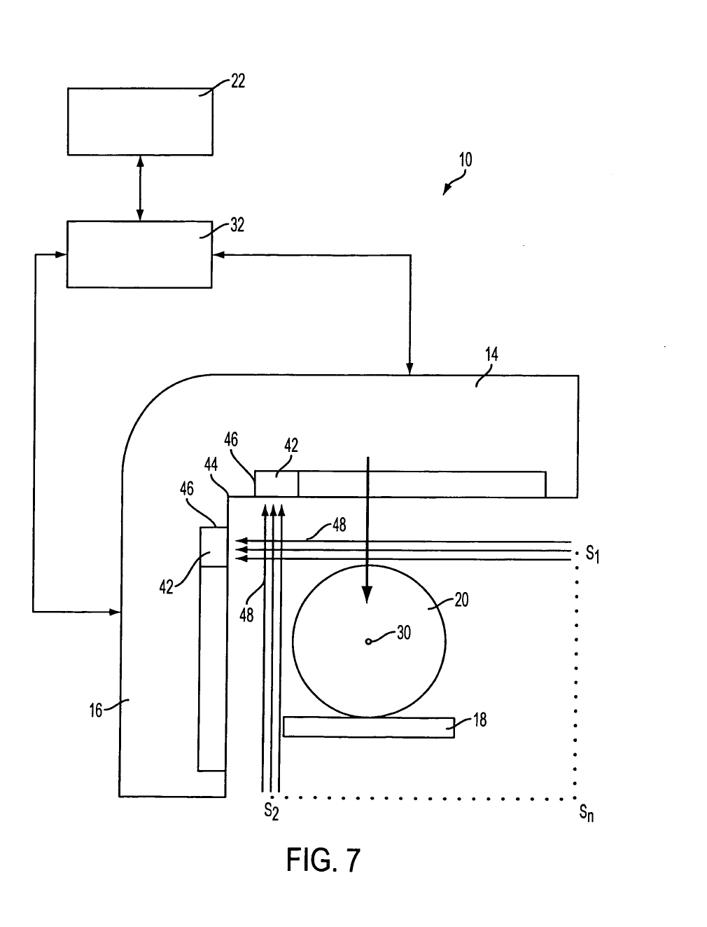

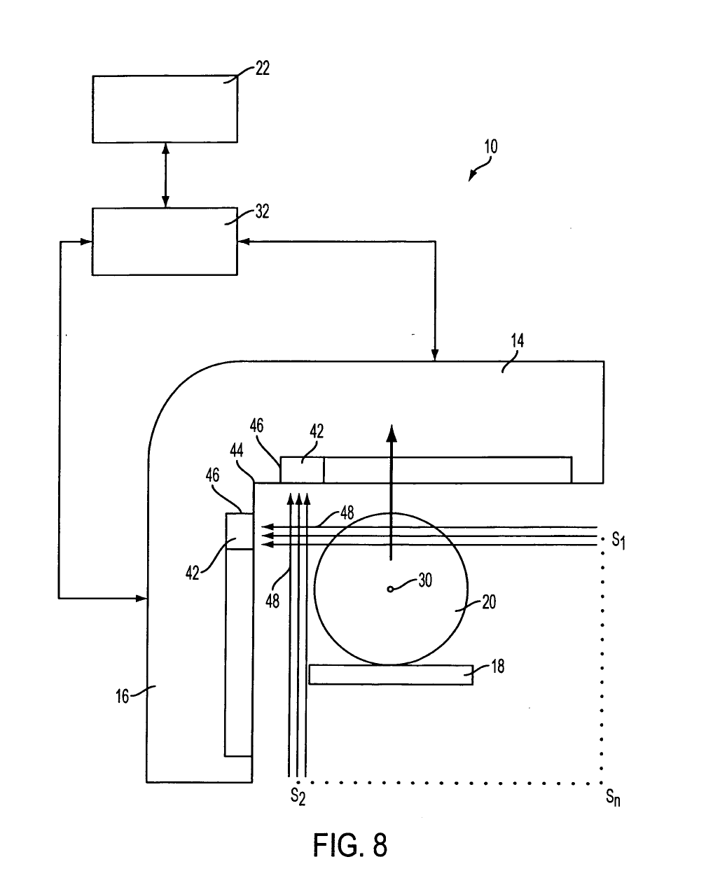

Similarly, FIGS. 7 and 8 illustrate conditions wherein the spatial window 42 of detector 16 receives non-attenuated radiation and attenuated radiation from a known external radiation source S₁, respectively. As shown in FIG. 7, when the spatial window of detector 16 receives non-attenuated radiation from known radiation source S₁, and/or the counts (C) or energy level range received within the spatial window is above a certain threshold, the control unit 22 directs detector 14 toward the subject, in the direction of the downwardly directed arrow, until radiation received within spatial window 42 falls within a predetermined attenuation, count or energy level range. In contrast, as shown in FIG. 8, if the spatial window receives attenuated radiation, e.g., as being attenuated by the subject, and/or the counts or energy level range is below a certain predetermined threshold, the control unit directs detector 14 away from the subject, in the direction of the upwardly directed arrow, until radiation received within the spatial window 42 falls within the predetermined attenuation, count or energy level range.

Generally, control unit 22 in combination with one or more motors or actuators 32 directs movement of the detectors toward or away from a subject upon receiving data from the spatial windows 42. Accordingly, it is seen that detectors 14 and 16 can be moved in directions toward or away from the subject when the spatial windows 42 receive substantially non-attenuated or attenuated radiation, where the counts (C) fall above, or below, certain pre-determined thresholds, e.g., where C₁<C<C₂, or where radiation energy levels received within the spatial windows fall above or below predetermined criteria.

Consequently, because the position of the spatial windows within their respective FOVs is known, the position of the detectors relative to the subject can be determined without the need for additional sensing devices, such as laser beams or light sensors. It should also be appreciated that while FIGS. 2-10 illustrate the spatial windows as being positioned proximate and adjacent to inner sides of the FOV of each respective detector and at a preset distance D from each adjacent detector, spatial windows 42 can be positioned about their respective FOVs as may be desired. For example, control unit 22 can be used to specify those areas of an FOV that are to be designated as the spatial windows 42; alternatively, data pertaining to specific portions of the FOVs can be monitored for attenuated/non-attenuated radiation, number of counts, or radiation energy levels, etc. Alternatively, certain photodetectors can be assigned to comprise the spatial windows, if desired.

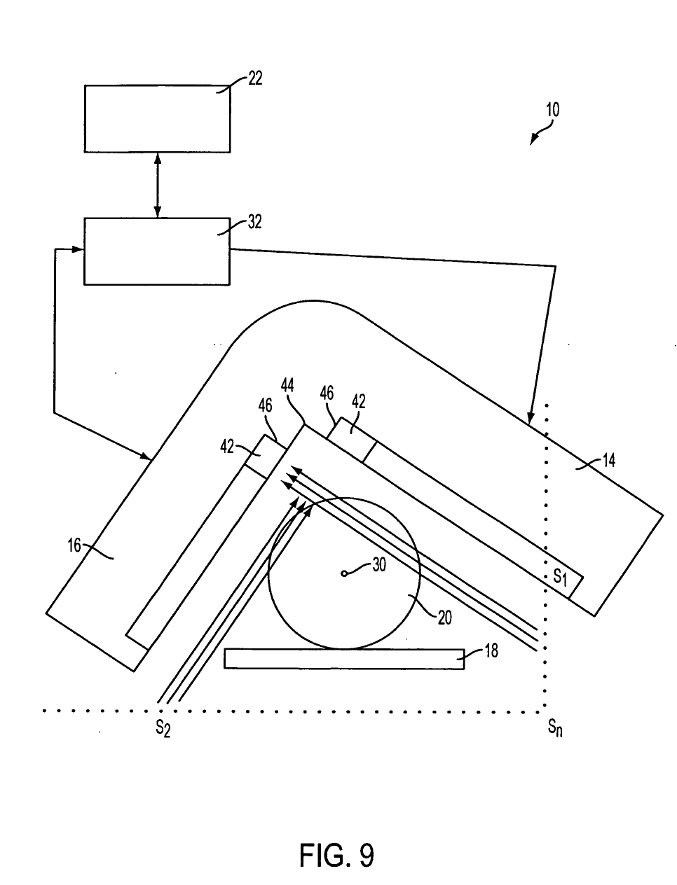

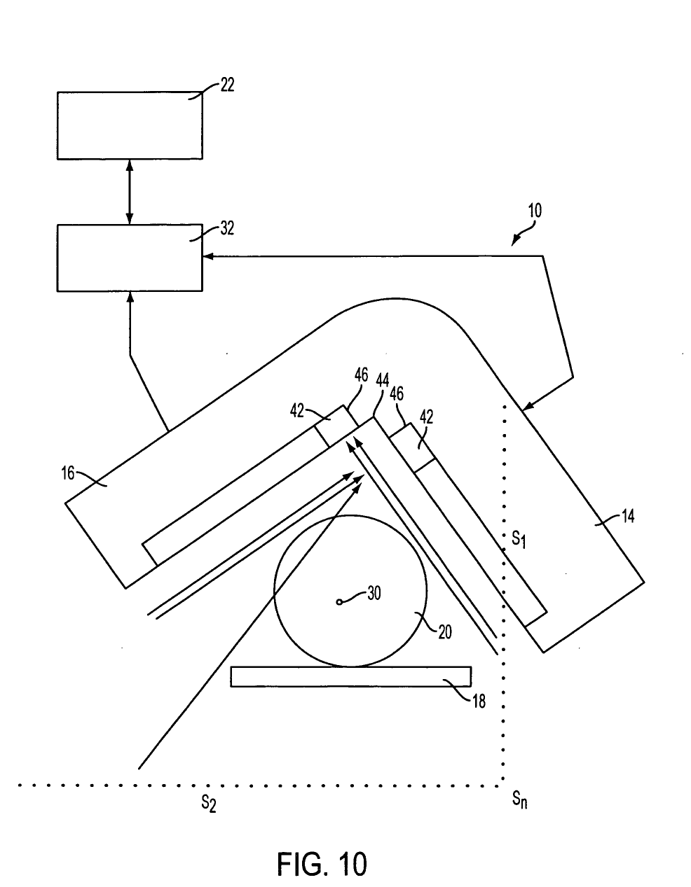

Because the position of detectors 14 and 16 relative to a subject can be determined using the spatial windows 42 and one or more known sources of radiation, an orbit or path about the subject can be calculated/determined prior to performing an imaging scan of the subject, e.g. a SPECT, PET, etc., imaging scan. In many instances, a substantially elliptical path about longitudinal axis 30 can be calculated, however, other paths or orbits about the subject can also be calculated/determined, e.g., circle, arcuate, portions thereof, or paths specifically calculated to correspond to the contour of a subject. As shown in FIGS. 9 and 10, a plurality of known points of radiation S₁, . . . Sₙ or S₂ . . . Sₙ can be used to calculate/determine a path or orbit specific to the contour of a subject. As shown in FIG. 9, a plurality of known points of radiation S₁, . . . Sₙ and S₂ . . . Sₙ can be disposed opposite detectors 16 and 14, respectively. When the detectors 14 and 16 are moved relative to the subject, e.g., rotated about longitudinal axis 30 of the subject, each of spatial windows 42 can be exposed to a different known point of radiation and receive attenuated/non-attenuated radiation 48 corresponding thereto. This data, thus, can then be used to calculate/determine a subject contour that can be used for subsequent imaging purposes. Alternatively, a single point of radiation can be re-positioned relative to a subject or a detector as a detector is moved relative to the subject or a point of radiation may be fixed relative to a detector for movement therewith.

In view of the above, a method for using a subject proximity detector according to the invention can be used, for example, as follows: a subject is positioned between one or more detectors and a known source of radiation, e.g., S₁, S₂ . . . Sₙ, and an initial reading taken regarding attenuation/non-attenuated radiation received within one or more spatial windows. Where radiation received in the one or more spatial windows 42 is substantially non-attenuated, one or more detectors is re-positioned relative to the subject, e.g., toward the subject, until the radiation received falls within a certain attenuation/non-attenuation range. Alternatively, where radiation received in the one or more spatial windows 42 is substantially attenuated, one or more detectors is re-positioned relative to the subject, e.g., away from the subject, until the radiation received falls within a certain attenuation/non-attenuation range. Where the radiation received within the one or more spatial windows falls within certain pre-determined criteria, the position of the one or more detectors relative to the patient can be calculated/determined and further used for purposes of calculating a path or orbit of the detectors about the subject or relative the subject, which can be a standard path or orbit, e.g., elliptical, circular, etc, or can be calculated to fit the contour of the subject. Alternatively, the subject can be moved relative the one or more detectors.

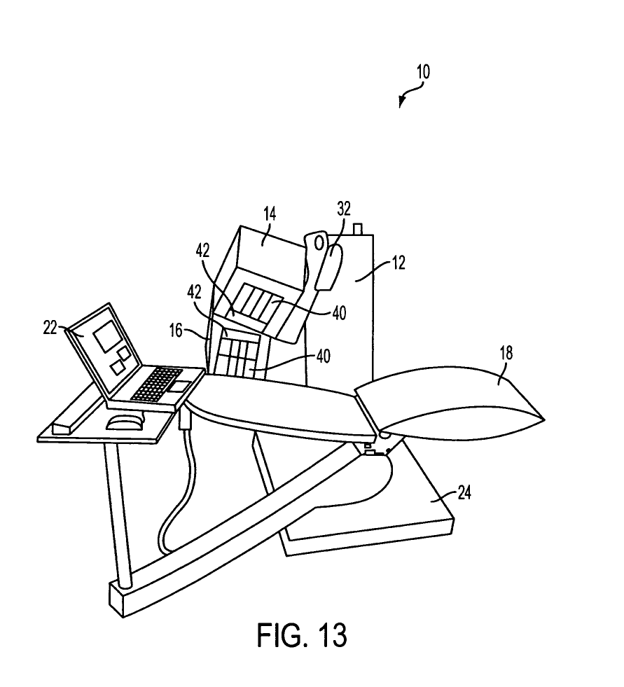

In view of the above, it is seen that a subject proximity detector is obtained without the need for additional devices to determine the position of detector relative to a subject, e.g., lasers and detectors therefor. While illustrative embodiments of the invention have been described herein, the present invention is not limited to the various embodiments described herein, but includes any and all embodiments having equivalent elements, modifications, omissions, combinations (e.g., of aspects across various embodiments), adaptations and/or alterations as would be appreciated by those in the art based on the present disclosure. For example, the present invention may be used with other types of imaging devices such as the C-CAM device manufactured by Siemens Medical Solutions USA, Inc. illustrated in FIG. 13, and wherein like components are labeled with like reference numbers as described above. In sum, the limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure, the terminology “orbit” encompasses, among other things, a path fully around a subject, such as, e.g., a patient or a path only partially around a subject, such as, e.g., a patient.

1. A method for spatially positioning one or more detectors of a nuclear imaging device in proximity to a subject, said method comprising:
disposing a subject between a source of radiation and a field of view of said one or more detectors;
receiving radiation emanating from said source within a spatial window of said field of view, said received radiation having a magnitude substantially corresponding to a position of said one or more detectors with respect to said subject;
determining a spatial location of said subject with respect to said one or more detectors based on the magnitude of said radiation received within said spatial window; and
positioning said one or more detectors or said subject relative to the other based on said determined spatial location.

2. The method of claim 1 wherein determining the spatial location of said subject comprises radially disposing said one or more detectors with respect to an axis of said subject.

3. The method of claim 1 wherein determining the spatial location of said subject further comprises transaxially rotating said one or more detectors about an axis of said subject.

4. The method of claim 1 wherein determining the spatial location of said subject further comprises disposing said one or more detectors along an axis of said subject.

5. The method of claim 2 wherein said one or more detectors is radially disposed away from an axis of said subject when said spatial window receives attenuated radiation with respect to said source.

6. The method of claim 2 wherein said one or more detectors is radially disposed toward an axis of said subject when said spatial window receives non-attenuated radiation with respect to said source.

7. The method of claim 1 wherein said spatial window is adjacent to an edge of said field of view of said one or more detectors.

8. The method of claim 1 wherein said nuclear imaging device comprises first and second detectors disposed at a predetermined angle with respect to one another, each of said first and second detectors configured for receiving radiation emanating from said source within a spatial window thereof, said first detector being disposed away from said subject when said spatial window of said second detector receives substantially attenuated radiation with respect to said source, and toward said subject when said spatial window of said second detector receives substantially nonattenuated radiation with respect to said source, said second detector being disposed away from said subject when said spatial window of said first detector receives substantially attenuated radiation with respect to said source and toward said subject when said spatial window of said first detector receives substantially non-attenuated radiation with respect to said source.

9. The method of claim 8 wherein said angle is adjustable.

10. The method of claim 9 wherein said angle is 90°.

11. The method of claim 1, further comprising calculating an orbital imaging path for said one or more detectors about and along the subject based on said spatial location of said subject.

12. A method for spatially positioning one or more detectors of a nuclear imaging device in proximity to a subject and obtaining a nuclear image of said subject, said method comprising:
disposing a subject between a source of radiation and a field of view of said one or more detectors;
receiving radiation emanating from said source within a spatial window of said field of view, said radiation having a magnitude substantially corresponding to a position of said one or more detectors with respect to said subject;
determining a spatial location of said subject with respect to said one or more detectors based on the magnitude of said radiation received within said spatial window;
positioning said one or more detectors or said subject relative to the other based on said determined spatial location; and,
scanning said subject at said positioning to obtain a nuclear image thereof.

13. A nuclear imaging device for spatially positioning one or more detectors in proximity to a subject, said device comprising:
at least one external source of radiation;
at least one detector disposed so as to image said subject, said at least one detector comprising a spatial window for receiving radiation from said at least one external source; and
a positioning assembly for adjusting a position of said at least one detector toward or away from said subject based on the magnitude of radiation received at said spatial window from said at least one external source.

14. The nuclear imaging device of claim 13, further comprising a second detector having a spatial window and a second external source of radiation, said positioning assembly being configured to adjust said at least one detector away from said subject when said spatial window of said second detector receives substantially attenuated radiation with respect to said second external source and toward said subject when said spatial window of said second detector receives substantially non-attenuated radiation with respect to said second external source, said positioning assembly being further configured to adjust said second detector away from said subject when said spatial window of said at least one detector receives substantially attenuated radiation with respect to said at least one external source and toward said subject when said spatial window of said at least one detector receives substantially non-attenuated radiation with respect to said at least one external source.

15. The nuclear imaging device of claim 14, wherein said detectors are disposed at an adjustable angle with respect to each other.

16. The nuclear imaging device of claim 15, wherein said angle is 90°.

17. The nuclear imaging device of claim 13, wherein said spatial window is adjacent to an inward edge of said field of view of said one or more detectors.

18. The nuclear imaging device of claim 13 wherein said one or more detectors are configured to be radially disposed with respect to an axis of said subject.

19. The nuclear imaging device of claim 13 wherein said one or more detectors are configured to be transaxially disposed about an axis of said subject.

20. The nuclear imaging device of claim 13 wherein said detectors are configured to be disposed along an axis of said subject.

21. The nuclear imaging device of claim 13, further comprising a control unit for determining the spatial location of said subject based on the magnitude of said radiation received by said spatial window of said one or more detectors.

22. The nuclear imaging device of claim 21 wherein said control unit determines an orbital path of said one or more detectors about and along said subject based on said spatial location.

23. The nuclear imaging device of claim 21 wherein said control unit controls movement of said one or more detectors based on said spatial location.
